(19) United States
(12) Patent Application Publication
(10) Pub. No.: US 2025/0185536 A1
(43) Pub. Date: Jun. 12, 2025

(54) A ROBOTIC LAWN MOWER

(71) Applicant: HUSQVARNA AB, Huskvarna (SE)

(72) Inventor: Olle HJELMAKER, Jonkoping (SE)

(21) Appl. No.: 18/846,267

(22) PCT Filed: Jan. 12, 2023
(86) PCT No.: PCT/SE2023/050034

§ 371 Date: Sep. 12, 2024

(30) Foreign Application Priority Data
Apr. 4, 2022 (SE) 2250428-6

(51) Int. Cl. A01D 34/00; A01D 34/78; A01D 34/81; A01D 34/82; A01D 101/00; G05D 1/661; G05D 105/15

(52) U.S. Cl. CPC A01D 34/008; A01D 34/78; A01D 34/81; A01D 34/82; G05D 1/661; A01D 2101/00; G05D 2105/15

(57) ABSTRACT

The present disclosure relates to a robotic lawn mower (100) having a body (140), at least two drive wheels (130a, 130b), a grass cutting mechanism (160), at least two electric motor arrangements (150, 165) and a control unit (110) adapted to control the operation of the robotic lawn mower (100). The said drive wheels (130a, 130b) are drivably connected to a first electric motor arrangement (150) and the cutting mechanism (160) is drivably connected to a second electric motor arrangement (165). The control unit (110) is configured to generate a cleaning request signal and generate a drive signal for actuating said drive wheels (130a, 130b) so as to guide said lawn mower (100) to an external cleaning station (230). Also, the control unit (110) is further configured to generate a movement signal for actuating said drive wheels (130a, 130b) to cause a relative movement of said lawn mower (100) in relation to said cleaning station (230) while allowing cleaning of at least a part of the underside of said lawn mower (100).

### TECHNICAL FIELD

The present disclosure relates to a robotic lawn mower which comprises a body, at least two drive wheels, a grass cutting mechanism, at least two electric motor arrangements and a control unit adapted to control the operation of the robotic lawn mower, wherein said drive wheels are drivably connected to a first electric motor arrangement.

### BACKGROUND

Robotic lawn mowers such as for example robotic lawn mowers are becoming increasingly more popular. A robotic lawn mower is usually battery-powered by means of a rechargeable battery and is adapted to cut grass on a user's lawn automatically. The robotic lawn mower can be charged automatically without intervention of the user, and does not need to be manually managed after being set once.

In a typical deployment a work area, such as a garden, park, sports field, golf court and the like, the work area is enclosed by a boundary wire with the purpose of keeping the robotic lawn mower inside the work area. An electric control signal may be transmitted through the boundary wire thereby generating an (electro-) magnetic field emanating from the boundary wire. The robotic working tool is typically arranged with one or more sensors adapted to sense the control signal.

Alternatively, or as a supplement, the robotic lawn mower can be equipped with a navigation system that is adapted for satellite navigation by means of GPS (Global Positioning System) or some other Global Navigation Satellite System (GNSS) system, for example using Real Time Kinematic (RTK).

Today's robotic lawn mowers are configured to operate in different types of demanding outdoor environments and in varying weather conditions. This means that such a lawn mower can be exposed to dirt, grass and soil residues and also part of plants and other material which may clog the cutting mechanism and other parts of the lawn mower. Such a situation may potentially lead to inferior performance or even damage to the lawn mower.

In order to avoid the above-mentioned problems, regular cleaning of the lawn mower is necessary. Such cleaning can obviously be carried out manually. However, automatic cleaning of a robotic lawn mower would be an advantage.

As regards the field of robotic lawn mowers, it is previously known from the document EP 2894532 that a sensor positioned on the housing of a robotic lawn mower can be cleaned through the use of an external cleaning arrangement.

Even though the above-mentioned solution provides efficient cleaning of a sensor device, there is still a need for improvements within the field or systems and methods for automatic cleaning of a robotic lawn mower. In particular, there is a desire for arrangements for removing grass, soil, plant parts and dirt from the operative parts of such a lawn mower, i.e. parts being associated with the propulsion arrangement and cutting mechanism of the lawn mower.

### SUMMARY

The object of the present disclosure is to provide a robotic lawn mower being configured for efficient and automatic cleaning, in particular cleaning of the operative parts of such a lawn mower, i.e. those parts which in particular are configured for cutting grass and for the propulsion of the lawn mower.

This object is achieved by means of robotic lawn mower having a body, at least two drive wheels, a grass cutting mechanism, at least two electric motor arrangements and a control unit adapted to control the operation of the robotic lawn mower. The drive wheels are drivably connected to a first electric motor arrangement and the cutting mechanism is drivably connected to a second electric motor arrangement. The control unit is being configured to generate a cleaning request signal and generate a drive signal for actuating said drive wheels so as to guide said lawn mower to an external cleaning station. Furthermore the control unit is further configured to generate a movement signal for actuating said drive wheels to cause a relative movement of said lawn mower in relation to said cleaning station while allowing cleaning of at least a part of the underside of said lawn mower.

In this way, the lawn mower may be actuated so as to move to the position of an external cleaning station when a cleaning request signal is generated. In this manner, cleaning can be carried out in particular with respect to the underside of the lawn mower. This means that the above-mentioned operative parts of the lawn mower, which normally need frequent cleaning from grass, soil, plant residues and other material, can be cleaned in an adequate manner.

According to some aspects, the control unit is configured for generating said movement signal so as to cause rotating movement of said lawn mower about a generally vertical axis, following an arcuate path, during said cleaning.

In this way, the lawn mower are moved laterally in an arcuate manner when the drive wheels are driven in different rotation directions by the first electric motor arrangement. More precisely, the lawn mower can be configured to be moved along a cleaning arc which makes the cleaning process efficient and simple.

According to some aspects, the robotic lawn mower comprises a first end portion, a second end portion and at least one swivelable wheel. The cutting mechanism comprises a rotatable grass cutting disc having a rotation axis and being drivably connected to the second electric motor arrangement. At least two drive wheels have a drive wheel axis with a center, and at least one swivelable wheel has a corresponding swivel axis. A swivel attachment axis, running through at least one swivel axis and being parallel to the drive wheel axis, is positioned between the second end portion and the drive wheel axis. The cutting disc is at least partly positioned between the swivel attachment axis and the second end portion.

In this way, the cutting disc is positioned such that it can move laterally in an arcuate manner when the drive wheels are driven in different rotation directions by the first electric motor arrangement. This enables the cutting disc to reach relatively close to a boundary.

According to some aspects, the lawn mower is provided with at least one generally arcuate protective wall extending along an end portion of said lawn mower, and wherein the control unit is configured for causing movement of said lawn mower generally along the arcuate extension of said protective wall.

According to some aspects, the robotic lawn mower comprises a first arcuate protective wall that at least partly runs along the second end portion, and at least one further arcuate protective wall, the protective walls extending from the body towards the ground during normal running, the protective walls being radially separated.

The protective walls confer an injury protection for humans and animals that come close to the second end portion during normal running, especially for the cutting disc disclosed. Furthermore, in this way, the above-mentioned cleaning arc is generally aligned with the arcuate shape of the protective wall, which contributes to efficient and quick cleaning of the lawn mower, in particular so as to prevent dirt and other unwanted material to affect the operative parts of the lawn mower.

According to some aspects, the control unit is configured for receiving a cleaning request signal which indicates a need for cleaning said protective wall.

According to some aspects, the control unit is configured for generating a movement signal causing a movement back and forth of the lawn mower in relation to the cleaning station, during said cleaning.

This means that the cleaning station in itself can be of a passive type.

According to some aspects, the cleaning request signal comprises environmentally based data or weather data which indicates that cleaning of said lawn mower is required.

According to some aspects, the cleaning request signal is generated based on information relating to the operating condition or a time schedule of operation of the lawn mower.

This means the generation of the cleaning request signal can be adapted to different situations and environments.

According to some aspects, said control unit is configured to generate said drive signal based on a sensor system guiding the lawn mower to a predetermined position at the cleaning station.

Furthermore, the above-mentioned object is obtained by means of an arrangement involving a robotic lawn mower as defined above and an associated external cleaning station.

Furthermore, the above-mentioned object is obtained by means of a method for controlling a robotic lawn mower.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present disclosure will become apparent when studying the appended claims and the following description. The skilled person realizes that different features of the present disclosure may be combined to create embodiments other than those described in the following, without departing from the scope of the present disclosure.

### BRIEF DESCRIPTION OF THE DRAWINGS

The present disclosure will now be described more in detail with reference to the appended drawings, where:

FIG. 1 shows a top view of a robotic lawn mower;

FIG. 2 shows a bottom view of the robotic lawn mower;

FIG. 3 shows a side perspective bottom view of the robotic lawn mower;

FIG. 4 shows a side perspective bottom view of an enlarged part the robotic lawn mower;

FIG. 5 shows a side view of the robotic lawn mower;

FIG. 6 shows a schematic view of a movement pattern of the robotic lawn mower during cutting of grass;

FIG. 7 shows a schematic view of a movement pattern of the robotic lawn mower during cleaning of said lawn mower;

FIG. 8 is a perspective view showing the robotic lawn mower as it approaches a cleaning station;

FIG. 9 shows a flowchart for methods according to the present disclosure;

FIG. 10 shows a schematic view of a control unit;

FIG. 11 shows a computer program product,

FIG. 12 shows a bottom view of a robotic lawn mower with a laterally offset cutting disc; and

FIG. 13 shows a bottom perspective view of a guard.

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the present disclosure. As used herein, the singular forms “a”, “an” and “the” are intended to include the plural forms as well, unless the context clearly indicates otherwise.

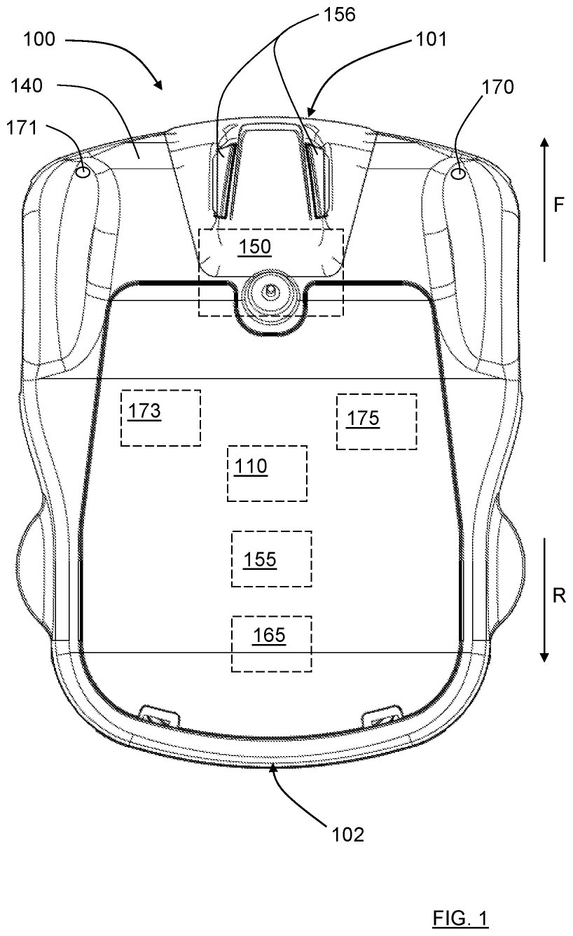

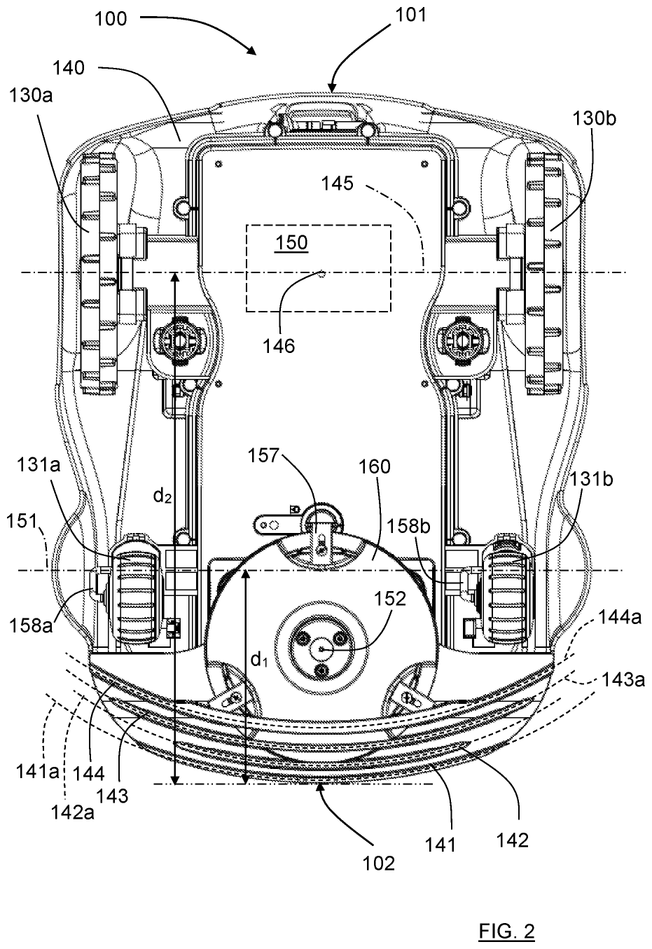

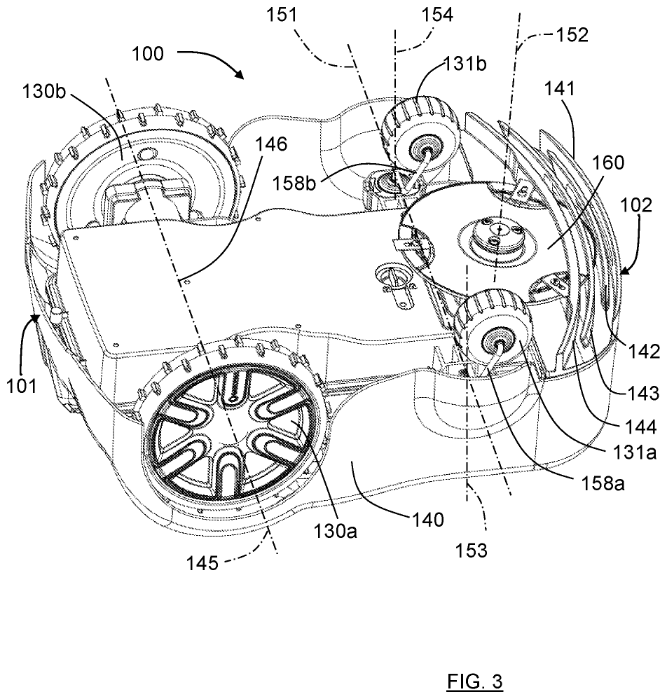

FIG. 1 shows a top view of a robotic lawn mower 100, FIG. 2 shows a bottom view of the robotic lawn mower 100, and FIG. 3 shows a side perspective bottom view of the robotic lawn mower. The robotic lawn mower 100 has a first end portion 101 and a second end portion 102, is adapted for a forward travelling direction F and a reverse travelling direction R. According to some aspects, the first end portion 101 is facing the forward travelling direction F and the second end portion 102 is facing the reverse travelling direction R. The robotic lawn mower 100 comprises a body 140, at least two drive wheels 130a, 130b, at least one swivelable wheel 131a, 131b, a control unit 110 adapted to control the operation of the robotic lawn mower 100, a cutting mechanism in the form of a rotatable grass cutting disc 160 having a rotation axis 152, and at least two electric motor arrangements 150, 165 (only schematically indicated in FIG. 2). At least one swivelable wheel has a corresponding swivel axis 153, 154.

According to some aspects, as illustrated in this example, the robotic lawnmower 100 comprises four wheels, two larger drive wheels 130a, 130b and two smaller swivelable wheels 131a, 131b that are in form of castor wheels and are arranged to swivel around a corresponding swivel axis 153, 154 when the robotic lawn mower 100 is turning. For this purpose, the swivelable wheels 131a, 131b are connected to the body 140 by means of corresponding swivel wheel holders 158a, 158b, where, according to some aspects, it is the swivel wheel holders 158a, 158b that swivel in relation to the body and are fixed in relation to the swivelable wheels 131a, 131b. The opposite is of course conceivable.

The description above and FIG. 1 describes one possible embodiment. According to further aspects, the robotic lawn mower may be provided with two drive wheels and one or more additional wheels which may or may not be swivelable. In the event that the additional wheels are not swivelable, components such as the swivel wheel holders 158a, 158b not necessary.

The robotic lawn mower 100 may be a multi-chassis type or a mono-chassis type. A multi-chassis type comprises more than one body parts that are movable with respect to one another. A mono-chassis type comprises only one main body part. In this example embodiment, the robotic lawnmower 100 is of a mono-chassis type, having a main body part 140. The main body part 140 substantially houses all components of the robotic lawnmower 100.

The robotic lawnmower 100 also comprises at least one rechargeable electric power source such as a battery 155 (only schematically indicated in FIG. 1) for providing power to the electric motor arrangements 150, 165. The battery 155 is arranged to be charged by means of received charging current from a charging station, received through charging skids 156 or other suitable charging connectors. Inductive charging without galvanic contact, only by means of electric contact, is also conceivable. The battery is generally constituted by a rechargeable electric power source 155 that comprises one or more batteries that can be separately arranged or be arranged in an integrated manner to form a combined battery.

According to some aspects, the robotic lawnmower 100 may further comprise at least one navigation sensor arrangement 175 and/or at least one wire sensor 173 (only schematically indicated in FIG. 1). In one embodiment, the navigation sensor arrangement 175 comprises one or more sensors for deduced navigation. Examples of sensors for deduced reckoning are odometers, accelerometers, gyroscopes, and compasses to mention a few examples. The navigation sensor arrangement 175 may comprise a satellite navigation sensor such as a GPS (Global Positioning System) device or other Global Navigation Satellite System (GNSS) device, according to some aspects for example using Real Time Kinematic (RTK).

The wire sensor 173 is adapted to sense a boundary wire control signal and/or at least one environment detection device 170, 171 adapted to detect objects. In this example, radar transceivers 170, 171 are provided and adapted to transmit signals and to receive reflected signals that have been reflected by an object. Other environment detection devices such as camera devices, ultrasonic devices and Lidar devices are of curse also conceivable, as alternatives or in any suitable combination.

The control unit 110 is adapted to control the environment detection device 170, 171 and to control the speed and direction of the robotic lawn mower 100 in dependence of information acquired by means of the of the environment detection devices 170, 171 and/or said wire sensor 173 when the robotic lawn mower 100 is moving.

The drive wheels 130a, 130b have a drive wheel axis 145 with a center 146 and are drivably connected to a first electric motor arrangement 150. A swivel attachment axis 151, running through at least one swivel axis 153, 154 and being parallel to the drive wheel axis 145, is positioned between the second end portion 102 and the drive wheel axis 145. This means that a largest first axis distance di between the swivel attachment axis 151 and the second end portion 102 falls below a largest second axis distance d₂ between the drive wheel axis 145 and the second end portion 102.

According to some aspects, at least two drive wheels 130a, 130b form a pair of drive wheels having the drive wheel axis 145 with the center 146, the center being positioned between the drive wheels 130a, 130b in the pair.

The first electric motor arrangement 150 is adapted to drive the drive wheels 130a, 130b in the same rotation direction, or in different rotation directions, and at different rotational speeds. According to some aspects, the first electric motor arrangement 150 comprises two separate electrical motors, and according to some further aspects each such electric motor is mounted to a corresponding drive wheel 130a, 130b, for example in a corresponding drive wheel hub.

According to further aspects, the robotic lawn mower may be provided with drive wheels which are in the form of hub wheel motors. In such case, no drive wheel axis extending between the two drive wheels is necessary.

The cutting disc 160 is drivably connected to a second electric motor arrangement 165 which in this example is in the form of a cutter motor. According to some aspects, the cutting disc 160 comprises a plurality of cutting knives 157, in this example three cutting knives 157 are shown (only one indicated in FIG. 2).

According to some aspects, in this example the cutting disc 160 is at least partly positioned between the swivel attachment axis 151 and the second end portion 102.

This means that at least some part of the cutting disc 160 is positioned closer to the second end portion 102 than any part of the swivel attachment axis 151.

In this way, the cutting disc 160 is positioned such that it can move laterally in an arcuate manner when the drive wheels 130a, 130b are driven in different rotation directions by the first electric motor arrangement 150.

According to some aspects, the rotation axis 152 is positioned between the swivel attachment axis 151 and the second end portion 102 when the rotation axis 152 passes through the cutting disc 160. In this manner, the cutting disc 160 can easily follow the movement of the second end portion 102, in particular when the drive wheels 130a, 130b are driven in different rotation directions by the first electric motor arrangement 150.

An example where the advantages of the placement of the rotation axis 152 of the cutting disc 160 will be described in the following.

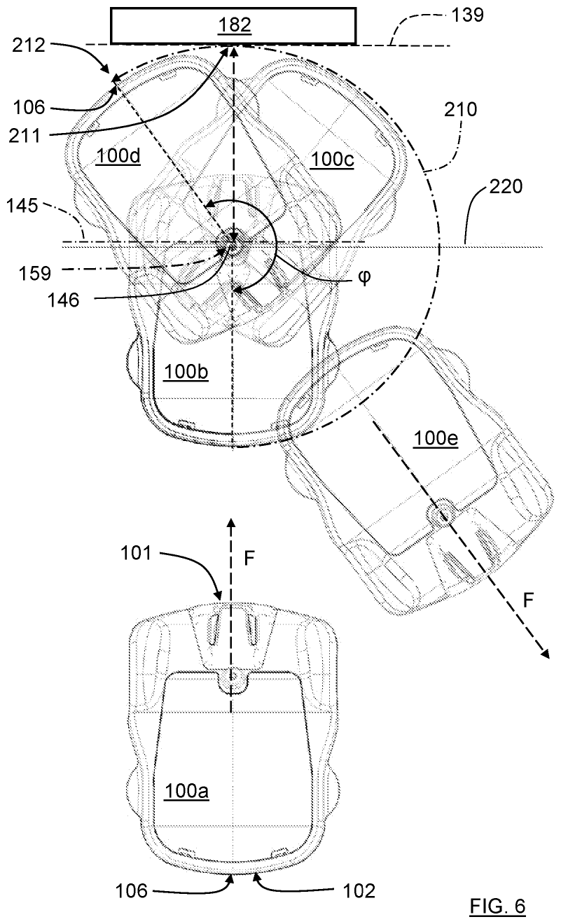

According to some aspects, with reference to FIG. 6, the control unit 110 is adapted to control the robotic lawn mower 100a to move towards a boundary 182, 220 in a forward travelling direction F of the robotic lawn mower 100 such that the first end portion 101 approaches the boundary 182, 220, and to determine if a distance to the boundary 182, 220 fulfills a condition. When the condition is fulfilled, the control unit 110 is adapted to stop the robotic lawn mower 100b, and to control the drive wheels 130a, 130b to turn in mutually different directions such that the second end portion 102 of the robotic lawn mower 100c, 100d performs an arcuate movement along a cutting arc 210, enabling the cutting disc 160 to cut grass within the cutting arc 210. FIG. 6 thus illustrates the robotic lawn mower 100a, 100b, 100c, 100d, 100e in a plurality of different positions taken at different times. In this way, cutting the grass relatively close to the boundary is enabled.

According to some aspects, the boundary is in the form of a boundary wire 220 defining an operation area for the robotic lawn mower 100, where the control unit 110 is adapted to stop the robotic lawn mower 100b when the robotic lawn mower 100 is positioned on the boundary wire 220. The robotic lawn mower 100b is then positioned a certain distance away from a lawn edge 139, the boundary wire 220 being positioned a certain distance away from a lawn edge 139. This distance is adapted such that the grass is cut until the lawn edge 139 when the robotic lawn mower 100c, 100d performs the arcuate movement, the cutting arc 210 having a closest arc portion 211 that is closest to the lawn edge 139. In this example, the condition relates to a determined distance between the boundary wire 220 and the robotic lawn mower 100 falling below a first threshold. This means that some predetermined reference point of the robotic lawn mower 100 falls below the second threshold, for example the wire sensor 173.

According to some aspects, the boundary is in the form of an object 182, the robotic lawn mower 100b is then positioned a certain distance away from the object 182, the distance being adapted such that the grass is cut until the object 182 when the robotic lawn mower 100c, 100d performs the arcuate movement, the cutting arc 210 having a closest arc portion 211 that is closest to the object 182. In this example, the condition relates to a determined distance between the object 182 and the robotic lawn mower 100 falling below a second threshold. This means that some predetermined reference point of the robotic lawn mower 100 falls below the second threshold, for example at least one environment detection device 170, 171.

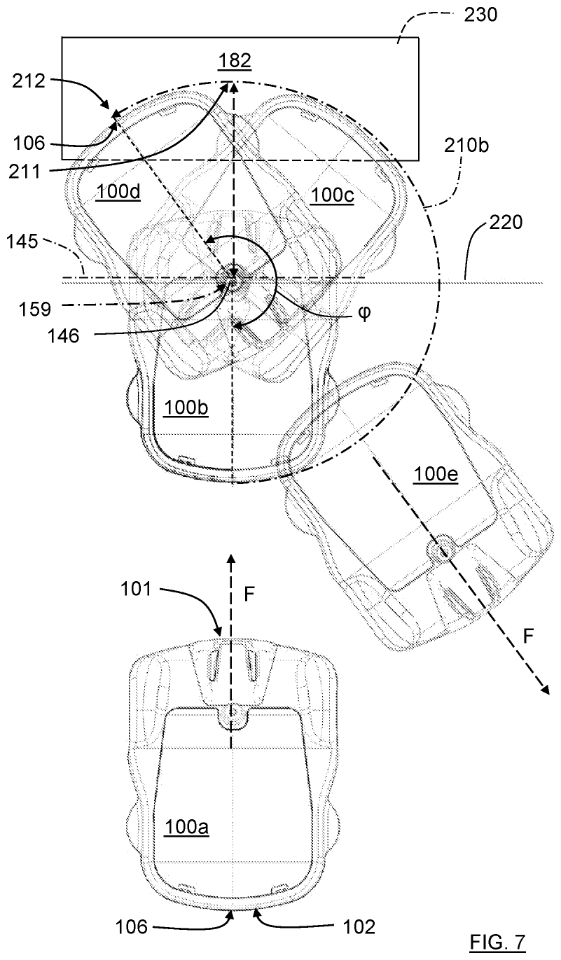

According to some aspects, as shown in FIG. 7, the robotic lawn mower 100b can be configured to initiate a cleaning procedure. More precisely, the control unit 110 can be configured for generating a cleaning request signal, which for example can based on a pre-programmed cleaning time schedule of the lawn mower 100b which can be stored in the storage medium, e.g. a memory unit, of the lawn mower 100b and which can be used by the control unit 110.

According to further aspects, the above-mentioned cleaning request signal can also be initiated based on a particular occurring weather condition. In such a case, the control unit 110 can be configured with communication means for receiving information from an external weather station which transmits weather information.

Consequently, the control unit 110 is configured for generating said cleaning request signal and to generate a drive signal, the purpose of which is to actuate the drive wheels 130a, 130b so as to guide the lawn mower 100b in a direction towards an external cleaning station 230. As shown in FIG. 7, the cleaning station 230 is shown in a schematical manner as an arrangement to which the lawn mower 100b is guided.

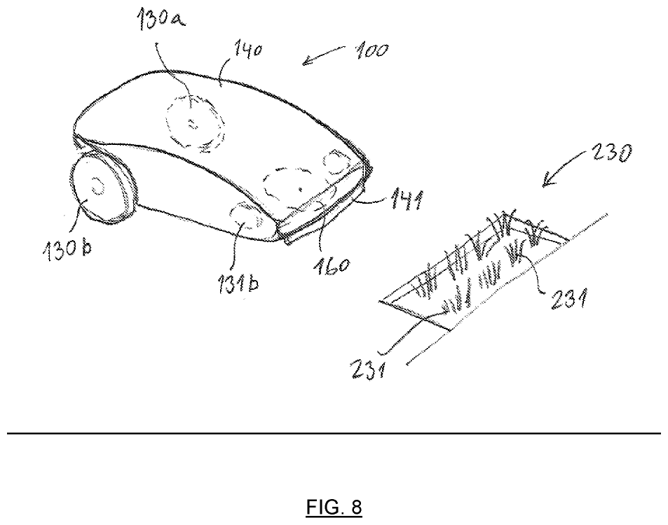

With reference also to FIG. 8, showing an operating condition in which the lawn mower 100 approaches the cleaning station 230, there is disclosed that the cleaning station 230 can be positioned within a zone of rectangular or otherwise suitable shape and which is provided with a cleaning device 231. According to an aspect, the cleaning device 231 comprises a plurality of brushes 231 or similar tools.

Furthermore, the cleaning station 230 is arranged generally along the same horizontal plane along which the lawn mower 100 moves, and in a manner so that the cleaning device 231 will be positioned below the underside of the lawn mower 100b. This means that the lawn mower 100 may be guided to the cleaning station 230 in a manner so that it is at least partly positioned above the cleaning station 230 so that the underside of the lawn mower 100 is within the reach of the brushes 231.

According to certain aspects, the control unit 110 is configured to generate a movement signal so as to actuate the drive wheels 130a, 130b to cause a relative movement of the lawn mower 100 in relation to the cleaning station 230. This is carried out while carrying out a cleaning of at least a part of the underside of the lawn mower 100.

According to certain aspects, when the lawn mower 100b has been guided towards the cleaning station 230, the cutting disc 160 is stopped so that it does not rotate when the cleaning process is carried out.

Furthermore, according to certain aspects, the control unit 110 is configured for generating the movement signal so as to cause rotating movement of said lawn mower 100 about a generally vertical axis 146, thereby following a generally arcuate path, during said cleaning. This is shown in FIG. 7, which indicates that said arcuate path 210b defines a cleaning arc along which the lawn mower 100b moves during the cleaning process.

According to alternative aspects, the control unit 110 is configured for generating a movement signal which causes a movement back and forth of the lawn mower 100 in relation to the cleaning station 230 during said cleaning. This is an alternative pattern of movement of the lawn mower 100 which is suitable in certain situations.

According to some aspects, a center 159 of the cutting arc 210 is positioned along the drive wheel axis 145. According to some further aspects, the center 159 of the cutting arc 210 is positioned in the center 146 of the drive wheel axis 145. This is the case when the drive wheels 130a, 130b are driven in different rotation directions and at the same rotation velocities by the first electric motor arrangement 150. Of course, this should not be interpreted literally, since small deviations can occur due to motor inaccuracies, uneven ground, uneven ground contact and uneven ground friction. The velocities being the same and the center 159 of the cutting arc 210 being positioned in the center 146 of the drive wheel axis 145 should be interpreted according to what is intended and practically achievable, not to be mathematically exact.

According to some aspects, the cutting arc 210 has an angular extension q that exceeds 180°, where the control unit 110 is adapted to control the robotic lawn mower 100e to continue moving forward when a second end center 106, according to some aspects constituting a rearmost point, that has followed the extension of the cutting arc 210 has reached an end 212 of the cutting arc 210. This means that the robotic lawn mower 100e will continue moving at an angle to the original angle of approach, away from the boundary 182, 220. This in turn enables the robotic lawn mower 100 to repeat the above procedure, performing arcuate movements, such that a continuous grass edge close to the boundary 182, 220 is cut. This can be performed in combination with cutting the rest of the grass on the lawn.

As explained above, a cleaning arc 210b (see FIG. 7) can be defined in a manner which corresponds to the cutting arc 210 (see FIG. 6).

According to some aspects, the lawn mower 100 can be adapted to be set in a mode where only a continuous grass edge close to the boundary 182, 220 is cut, the rest of the lawn not being cut during that time. This mode could be selected by a user.

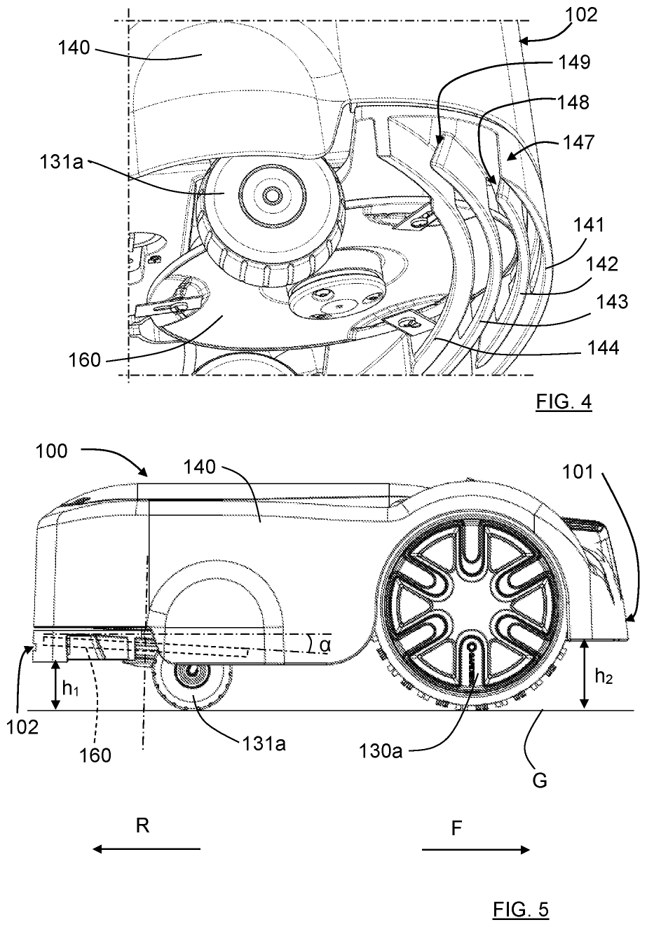

According to some aspects, also with reference to FIG. 4 and FIG. 5, the robotic lawnmower 100 further comprises a first arcuate protective wall 141 that at least partly runs along the second end portion 102, and at least one further arcuate protective wall 142, 143, 144, the protective walls 141, 142, 143, 144 extending from the body 140 towards the ground G during normal running, the protective walls 141, 142, 143, 144 being radially separated.

In this examples, there are four protective walls 141, 142, 143, 144; the first protective wall 141, a second protective wall 142, a third protective walls 14, and a fourth protective wall 144. Since the cutting disc 160 is at least partly positioned between the swivel attachment axis 151 and the second end portion 102, and, according to some aspects, the rotation axis 152 is positioned between the swivel attachment axis 151 and the second end portion 102 when the rotation axis 152 passes through the cutting disc 160, the protective walls 141, 142, 143, 144 confer an injury protection for humans and animals that come close to the second end portion 102 during normal running.

There is a first distance h₁ between the first protective wall 141 and the ground G, where the first distance h₁ of course varies slightly during running. There is a second distance h₂ between the first end portion 101 and the ground G, where the second distance h₂ of course also varies slightly during running. In this example, the first distance h₁ falls below the second distance h₂, and in the case of the first end portion 101 is facing the forward travelling direction F, this means that relatively high grass can enter between the robotic lawnmower 100 and the ground G without being bent, or only being slightly bent, before reaching the cutting disc 160. A spring-back effect for bent grass can need an additional distance and thus also an additional time to bend back.

This is advantageous since this provides a more efficient cut of the grass, and is enabled by having the cutting disc 160 positioned relatively close to the second end portion 102 where the cutting disc 160 is protected by means of the protective walls 141, 142, 143, 144.

Due to the above-mentioned problem related to the fact that a lawn mower can be exposed to dirt, grass, part of plants and other material which may clog different parts of the lawn mower, it is particularly suitable to provide cleaning of the protective walls 141, 142, 143, 144 and the spaces between these walls. This will be described in greater detail below.

According to some aspects, the protective walls 141, 142, 143, 144 are partly positioned between the cutting disc 160 and the ground G during normal running. In this manner, the cutting disc 160 can reach the second end portion 102 while humans and animals that come close to the second end portion 102 during normal running still are protected from injury.

According to some aspects, the protective walls 141, 142, 143, 144 at least mainly follow respective protective wall arcs 141a, 142a, 143a, 144a, where all protective wall arcs 141a, 142a, 143a, 144a have a common center 146. According to some aspects, the common center 146 is the center of the drive wheel axis 145. In this way, when the arcuate movement is performed, the grass will not be bent when moving between the protective walls 141, 142, 143, 144. According to some aspects, the radial separation of the protective walls 141, 142, 143, 144 relates to the common center.

According to some aspects, at least one protective wall 141, 142, 143 comprises tapered end portions 147, 148, 149. In this example, this is the case for the first three protective walls 141, 142, 143, and enables the grass to be easily divided between the protective walls 141, 142, 143, 144 when the arcuate movement is performed.

In summary, and according to some aspects, the lawn mower 100 is provided with at least one generally arcuate protective wall 141, 142, 143, 144 extending along an end portion of the lawn mower 100. Furthermore, the control unit 110 is suitably configured for causing movement of said lawn mower 100 generally along the arcuate extension of said protective wall 141. In this manner, optimal cleaning of the protective walls 141, 142, 143, 144 and the spaces between these walls can be provided.

According to some aspects, a center of the cutting arc is positioned along the drive wheel axis, if such a wheel axis is provided. In such case, and according to some aspects, the center of the cutting arc is positioned in the center of the drive wheel axis. This means that the arcuate movement can easily be performed by turning the drive wheels in mutually different directions.

The above-mentioned cleaning request signal may be generated according to a pre-programmed time schedule which indicates when cleaning of the lawn mower should suitably be provided. According to alternative aspects, the cleaning request signal can be initiated based on weather data which indicates that cleaning of said lawn mower 100 is required, for example when rain or heavy winds can be expected to have occurred. Such weather conditions may cause leaves, grass and plant parts to gather on the lawn on which the lawn mower 100 is located, which may clog the operative parts of the lawn mower 100.

According to yet further aspects, the cleaning request signal can be generated based on information relating to the operating condition of the lawn mower 100.

Furthermore, the control unit 110 is configured to generate the drive signal with the aid of the above-mentioned sensor system 175 which guides the lawn mower 100 to a predetermined position at the cleaning station 230.

According to some aspects, the cleaning station 230 may comprise a cleaning arrangement in the form of a water supply which is configured for ejecting water directed towards the underside of the lawn mower 100 during the cleaning process i.e., when the lawn mower has reached an initial cleaning position. According to further aspects, such a water supply can be used in combination with brushes of the kind which is shown in FIG. 8.

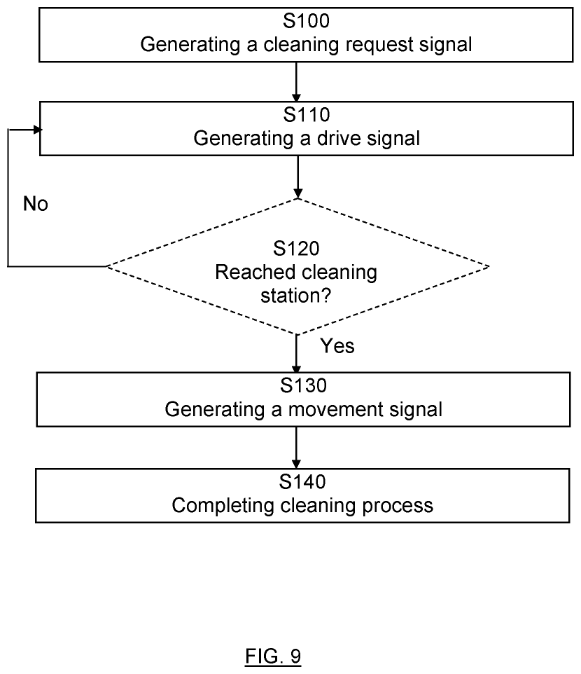

With reference to FIG. 9, the present disclosure also relates to a method for controlling a robotic lawn mower 100 having a body 140, at least two drive wheels 130a, 130b, a grass cutting mechanism 160, at least two electric motor arrangements 150, 165 and a control unit 110 adapted to control the operation of the robotic lawn mower 100, wherein said drive wheels 130a, 130b are drivably connected to a first electric motor arrangement 150 and the cutting mechanism 160 is drivably connected to a second electric motor arrangement 165.

The method comprises a step S100 of generating a cleaning request signal and a further step of S110 generating a drive signal for actuating the drive wheels 130a, 130b so as to guide the lawn mower 100 to an external cleaning station 230.

When the lawn mower 100 has reached the cleaning station 230—which is suitably determined by a further process step S120 in the control unit 110—a movement signal is generated in a further step S130 so as to actuate the drive wheels 130a, 130b and to cause relative movement of the lawn mower 100 in relation to the cleaning station 230. The cleaning process is carried out and completed S140 during a time period after which it can be expected that the underside and the operating parts are sufficiently cleaned.

As described above, the cleaning completion process S140 can be carried out by means of brushes 231 or a water supply, or a combination of both.

According to some aspects, the cleaning station 230 can be actuated for cleaning of at least a part of the underside of said lawn mower 100.

According to some aspects, the rotation axis 152 is positioned between the swivel attachment axis 151 and the second end portion 102 when the rotation axis 152 passes through the cutting disc 160.

According to some aspects, the cutting arc 210 has an angular extension that exceeds 180°, where the method comprises controlling S500 the robotic lawn mower 100e to continue moving after a second end portion center 106 following the extension of the cutting arc 210 has reached an end 212 of the cutting arc 210. The cleaning arc 210b is designed in a corresponding manner.

According to some aspects, the boundary is in the form of a boundary wire 220 defining an operation area for the robotic lawn mower 100, where stopping S300 of the robotic lawn mower 100 takes place when the robotic lawn mower 100 is positioned on the boundary wire 220, where the condition relates to a determined distance between the boundary wire 220 and the robotic lawn mower 100 falling below a first threshold.

According to some aspects, the boundary is in the form of an object 182, where the cutting arc has a closest arc portion 211 that is closest to the object 182, where the condition relates to a determined distance between the object 182 and the robotic lawn mower 100 falling below a second threshold.

According to some aspects, the cutting arc 210 has an angular extension that exceeds 180°, where the control unit 110 is adapted to control the robotic lawn mower 100e to continue moving when a second end center 106 that has followed the extension of the cutting arc 210 has reached an end 212 of the cutting arc 210.

According to some aspects, the method comprises using at least one wire sensor 173 to sense a boundary wire control signal and/or using at least one environment detection device 170, 171 to detect objects 182.

According to some aspects, the robotic lawn mower 100 is used for a forward travelling direction F and a reverse travelling direction R, where the first end portion 101 is facing the forward travelling direction F and the second end portion 102 is facing the reverse travelling direction R.

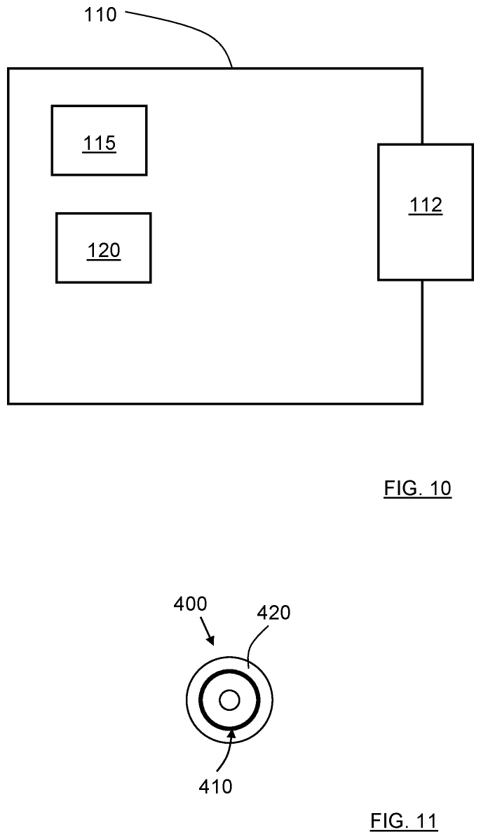

In FIG. 10 it is schematically illustrated, in terms of a number of functional units, the components of the control unit 110 according to embodiments of the discussions herein. Processing circuitry 115 is provided using any combination of one or more of a suitable central processing unit CPU, multiprocessor, microcontroller, digital signal processor DSP, etc., capable of executing software instructions stored in a computer program product, e.g. in the form of a storage medium 120. The processing circuitry 115 may further be provided as at least one application specific integrated circuit ASIC, or field programmable gate array FPGA. The processing circuitry thus comprises a plurality of digital logic components.

Particularly, the processing circuitry 115 is configured to cause the control unit 110 to perform a set of operations, or steps to control the operation of the robotic lawn mower 100 including, but not being limited to, controlling the radar transceivers 170, processing measurements results received via the radar transceivers 170, and the propulsion of the robotic lawn mower 100. For example, the storage medium 120 may store the set of operations, and the processing circuitry 115 may be configured to retrieve the set of operations from the storage medium 120 to cause the control unit 110 to perform the set of operations. The set of operations may be provided as a set of executable instructions. Thus, the processing circuitry 115 is thereby arranged to execute at least parts of the methods as herein disclosed.

The storage medium 120 may also comprise persistent storage, which, for example, can be any single one or combination of magnetic memory, optical memory, solid state memory or even remotely mounted memory.

According to some aspects, the control unit 110 further comprises an interface 112 for communications with at least one external device such as a user terminal. As such the interface 112 may comprise one or more transmitters and receivers, comprising analogue and digital components and a suitable number of ports for wireline communication. The interface 112 can be adapted for communication with other devices, such as the remote server 207, the charging station 215, and/or other robotic working tools. Examples of such wireless communication devices are Bluetooth®, WiFi® (IEEE802.11b), Global System Mobile (GSM) and LTE (Long Term Evolution), to name a few.

FIG. 11 shows a computer program product 400 comprising computer executable instructions 410 stored on media 420 to execute any of the methods disclosed herein.

The present disclosure is not limited to the above, but may vary freely within the scope of the appended claims. For example, the first end portion 101 can be facing the reverse travelling direction R and the second end portion 102 can be facing the forward travelling direction F.

The end portions 101, 102 are shown as arcuate portions facing a forward travelling direction F or rearward travelling direction R where, according to some aspects, the first arcuate protective wall 141 constitutes the second end portion 102. According to some aspects, an end portion 101, 102 can be defined as a rearmost of foremost point at the robotic lawn mower 100. According to some aspects, the first end portion 101 is opposite the second end portion 102, each end portion facing a travelling direction.

According to some aspects, the swivel attachment axis 151 runs via the points where the swivelable wheels 131a, 131b are connected to the body 140 by means of corresponding swivel wheel holders 158a, 158b.

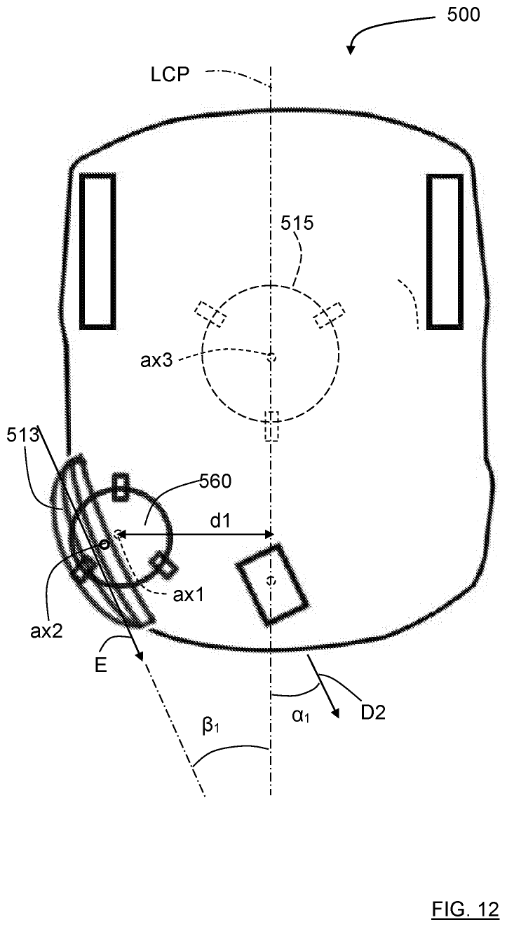

There can be other types of protective walls as illustrated in FIG. 12. There, a robotic lawn mower 500 having a laterally offset cutting disc 560 having an offset rotation axis ax1, where the offset rotation axis ax1 is arranged at a shortest first distance d1 from a longitudinal center plane LCP of the robotic lawnmower 1, where the longitudinal center plane LCP extends through a lateral center of the robotic lawnmower 500 in a vertical direction of the robotic lawnmower 500.

The robotic lawnmower 500 comprises a guard 513 covering at least a portion of the offset cutting unit 560, the guard 513 being attached to a pivot axle ax2 and arranged to pivot with the pivot axle ax2 in dependence of a travelling direction D2 of the robotic lawn mower 500. The guard 513 has a main longitudinal extension E that presents a first guard angle β₁ to the longitudinal center plane LCP in dependence of the travelling direction D2. For this reasons the guard is connected to a motor or other pivot means that enables it to pivot in dependence of the travelling direction D2.

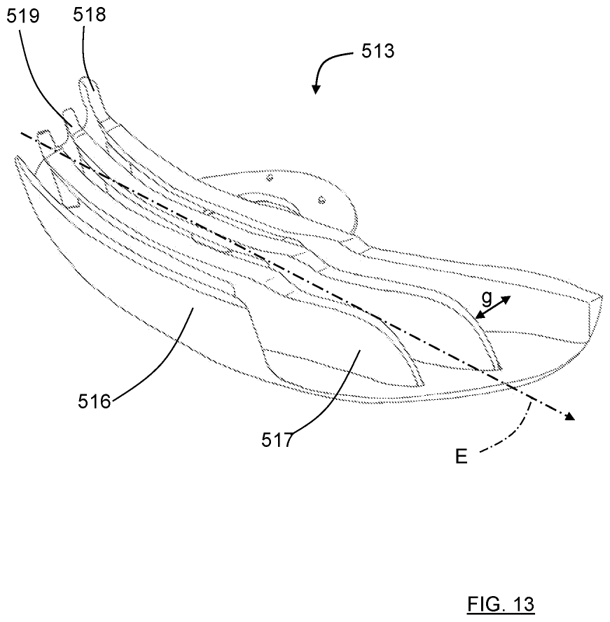

As shown in FIG. 13, the guard 513 comprises a plurality of laths 516, 517, 518, 519 that mainly run along the longitudinal extension E. This provides openings where debris can escape and/or be easily removed, while maintaining a high degree of safety. Preferably, gaps g between adjacent laths 516, 517, 518, 519 (one gap g indicated in FIG. 13) will not admit insertion of a human finger or toe.

According to some aspects, the robotic lawn mower 500 further comprises a center rotatable grass cutting disc 515 having a centered rotation axis ax3 arranged on the longitudinal center plane LCP.

Between these laths 516, 517, 518, 519 debris can get stuck as for the protective walls described above, and these can also be cleaned at the cleaning station 230. In the case of the cleaning station 230 comprising upwardly directed brushes 231, either the robotic lawn mower 500 performs a movement to enable cleaning, or the guard 513 is controlled to pivot with the pivot axle ax2 when in a cleaning position.

1. A robotic lawn mower having a body, at least two drive wheels, a grass cutting mechanism, at least two electric motor arrangements and a control unit adapted to control operation of the robotic lawn mower, wherein said at least two drive wheels are drivably connected to a first electric motor arrangement and the cutting mechanism is drivably connected to a second electric motor arrangement, said control unit being configured to generate a cleaning request signal and generate a drive signal for actuating said at least two drive wheels so as to guide said robotic lawn mower to an external cleaning station; wherein said control unit is further configured to generate a movement signal for actuating said at least two drive wheels to cause a relative movement of said robotic lawn mower in relation to said external cleaning station while allowing cleaning of at least a part of the underside of said robotic lawn mower.

2. The robotic lawn mower according to claim 1, wherein the control unit is configured for generating said movement signal so as to cause rotating movement of said robotic lawn mower about a generally vertical axis, following an arcuate path, during said cleaning.

3. The robotic lawn mower according to claim 1, wherein the robotic lawn mower comprises a first end portion, a second end portion and at least one swivelable wheel, wherein the cutting mechanism comprises a rotatable grass cutting disc having a rotation axis and being drivably connected to the second electric motor arrangement, wherein the at least two drive wheels have a drive wheel axis with a center, wherein at least one swivelable wheel has a corresponding swivel axis, wherein a swivel attachment axis, running through at least one swivel axis and being parallel to the drive wheel axis, is positioned between the second end portion and the drive wheel axis, and wherein the cutting disc at least partly is positioned between the swivel attachment axis and the second end portion.

4. The robotic lawn mower according to claim 1, wherein said robotic lawn mower is provided with at least one generally arcuate protective wall extending along an end portion of said robotic lawn mower, and wherein the control unit is configured for causing movement of said robotic lawn mower generally along the arcuate extension of said protective wall.

5. The robotic lawn mower according to claim 4, wherein the robotic lawn mower further comprises a first arcuate protective wall that at least partly runs along the second end portion, and at least one further arcuate protective wall, the first arcuate protective wall and the at least one further arcuate protective walls extending from the body towards the ground (G) during normal running, the first arcuate protective wall and the at least one further arcuate protective walls being radially separated.

6. The robotic lawn mower according to claim 4, wherein the control unit is configured for receiving a cleaning request signal which indicates a need for cleaning said protective wall.

7. The robotic lawn mower according to claim 1, wherein the control unit is configured for generating a movement signal causing a movement back and forth of the robotic lawn mower in relation to the cleaning station, during said cleaning.

8. The robotic lawn mower according to claim 1, wherein said cleaning request signal comprises environmentally based data or weather data which indicates that cleaning of said robotic lawn mower is required.

9. The robotic lawn mower according to claim 1, wherein said cleaning request signal is generated based on information relating to the operating condition or a time schedule of operation of the robotic lawn mower.

10. The robotic lawn mower according to claim 1, wherein the control unit is configured to generate said drive signal based on a sensor system guiding the robotic lawn mower to a predetermined position at the cleaning station.

11. An arrangement for cleaning the robotic lawn mower comprising the lawn mower according to claim 1 and an external cleaning station, said control unit being configured to generate a cleaning request signal, and generate a drive signal for actuating said at least two drive wheels so as to guide said robotic lawn mower to the cleaning station; wherein said control unit is further configured to generate a movement signal for actuating said at least two drive wheels to cause a relative movement of said robotic lawn mower in relation to said cleaning station during cleaning of at least a part of the underside of said robotic lawn mower.

12. The arrangement according to claim 11, wherein said cleaning station is at least partly positioned at a vertical position which is below a plane defining the extension of the cutting mechanism.

13. The arrangement according to claim 11, wherein said cleaning station comprises upwardly directed brushes configured for cleaning said underside of said robotic lawn mower.

14. The arrangement according to claim 11, wherein said cleaning station comprises a water supply which is configured for ejecting water towards the underside of the robotic lawn mower during said cleaning.

15. A method for controlling a robotic lawn mower having a body, at least two drive wheels, a grass cutting mechanism, at least two electric motor arrangements and a control unit adapted to control operation of the robotic lawn mower, wherein said at least two drive wheels are drivably connected to a first electric motor arrangement and the cutting mechanism is drivably connected to a second electric motor arrangement, said method comprising the following steps:
generating a cleaning request signal;
generating a drive signal for actuating said at least two drive wheels so as to guide said robotic lawn mower to an external cleaning station;
generating a movement signal for actuating said at least two drive wheels to cause a relative movement of said robotic lawn mower in relation to said cleaning station; and
completing a cleaning process.
